(19) United States
(12) Patent Application Publication
(10) Pub. No.: US 2025/0266058 A1
(43) Pub. Date: Aug. 21, 2025

(54) DISK DRIVE SUSPENSION

(71) Applicant: NHK SPRING CO., LTD., Yokohama-shi (JP)

(72) Inventor: Akira NOJIMA, Yokohama-shi (JP)

(73) Assignee: NHK SPRING CO., LTD., Yokohama-shi (JP)

(21) Appl. No.: 19/050,137

(22) Filed: Feb. 11, 2025

(30) Foreign Application Priority Data
Feb. 15, 2024 (JP) 2024-021019

(51) Int. Cl. G11B 5/48

(52) U.S. Cl. CPC G11B 5/4833

(57) ABSTRACT

A flexure of a suspension includes a metal base, a circuit portion, and a slider arrangement portion. The slider arrangement portion includes an aperture portion formed in the metal base and a slider support portion provided on the metal base. The aperture portion is provided at a position on which the slider is provided. An embedding circuit portion is provided inside the aperture portion. The embedding circuit portion constitutes a part of a length direction of the circuit portion. The slider support portion supports the slider with the embedding circuit portion being provided in the aperture portion. The embedding circuit portion has an abutting portion contacting a protrusion portion of a load beam.

### CROSS-REFERENCE TO RELATED APPLICATIONS

This application is based upon and claims the benefit of priority from prior Japanese Patent Application No. 2024-021019, filed Feb. 15, 2024, the entire contents of which are incorporated herein by reference.

### BACKGROUND OF THE INVENTION

### 1. Field of the Invention

The present invention relates to a disk drive suspension comprising a load beam, a flexure, and the like.

### 2. Description of the Related Art

A disk drive is used in an information processing apparatus such as a personal computer. The disk drive includes a magnetic disk rotatable about a spindle, a carriage pivotable about a pivot, etc. A disk drive suspension is provided on an arm of the carriage.

The disk drive suspension comprises a baseplate, a load beam, a flexure arranged along the load beam, and the like. The flexure includes a metal base composed of a thin stainless steel plate and a circuit portion provided along the metal base. The disk drive suspension is simply called a suspension hereinafter.

A swingable gimbal structure is formed near the tip of the flexure. The gimbal structure includes a slider arrangement portion on which the slider is arranged. A part of the flexure constituting the slider arrangement portion is called a tongue as well. The tongue is formed on a portion of the metal base. The gimbal structure is supported by a protrusion portion formed on the load beam. The protrusion portion is called a dimple as well in the industry. The apex of the protrusion portion (the apex of the dimple) supports the tongue in a swingable manner.

A slider functioning as a magnetic head is attached to the slider arrangement portion. The slider is provided with elements for accessing data, that is, for reading or writing data stored in a disk. The disk rotates, producing an air bearing between the slider and the disk. The distance between an air bearing formation surface of the slider and the disk surface (Head Media Spacing) is, for example, 10 nm or less. That is, the distance is significantly small.

JP 4993524 B (Patent Literature 1) discloses an example of the slider and the circuit portion. The circuit portion is connected to the slider. The circuit portion of Patent Literature 1 extends in the length direction of the flexure along a side surface and the other side surface of the slider. The slider is secured to a metal base of the flexure by bonding and the like. In this case, both sides of the slider necessitate space for the circuit portion. This configuration is disadvantageous for achieving more compact suspensions.

JP 5931624 B (Patent Literature 2) discloses another example of the suspension. The suspension includes a circuit portion between the rear surface of a slider and a metal base. That is, the metal base, the circuit portion, and the slider overlap in the thickness direction. In this case, an adhesive secures the rear surface of the slider to the circuit portion. This configuration can reduce the width of the slider arrangement portion and thus is advantageous for achieving more compact suspensions.

In the suspension of Patent Literature 2, the circuit portion and the slider overlap in the thickness direction. The circuit portion includes a plurality of independent conductors each covered by a cover resin. Thus, when these conductors and the cover resin are not flush with one another, the slider is inaccurately oriented, which is disadvantageous. Further, the metal base, the circuit portion, and the slider overlap in the thickness direction. This configuration further disadvantageously increases the distance between the apex of the dimple and the air bearing formation surface of the slider by the thickness of the circuit portion.

The present invention aims to provide a suspension capable of stabling an orientation of a slider provided on the slider arrangement portion.

### BRIEF SUMMARY OF THE INVENTION

An embodiment is a disk drive suspension comprising a load beam and a flexure. The flexure includes a metal base, a circuit portion provided along the metal base, and a slider arrangement portion on which the slider is arranged. The slider arrangement portion includes an aperture portion formed in the metal base, a slider support portion formed on the metal base, an embedding circuit portion constituting a part of a length direction of the circuit portion, and an abutting portion. The slider support portion supports the slider. A protrusion portion of the load beam abuts the abutting portion. The aperture portion is provided at a position in which the slider is provided. The slider is supported by the slider support portion with the embedding circuit portion being provided in the aperture portion.

An embodiment of the present invention can stable the orientation of the slider provided on the slider arrangement portion, in the suspension comprising the circuit portion, the slider arrangement portion, and the like.

In the suspension of the present embodiment, the embedding circuit portion may include a base resin layer, a conductor along the base resin layer, a cover resin covering the conductor, and an abutting portion. The slider arrangement portion may include a foundation resin overlapping the base resin layer. A metal portion composed of a part of the metal base may be provided inside the aperture portion. The metal portion may include the slider support member. The metal portion may include the abutting portion.

The embedding circuit portion may include a load beam-side face facing the load beam, a slider-side face facing the slider, a first conductor, and a second conductor. The first conductor includes a terminal portion exposed to the load beam-side face. The second conductor includes a terminal portion exposed to the slider-side face. A ground conductor for electrically connecting the metal base and the conductors of the embedding circuit portion may be provided.

The slider support portion may include the metal portion and an electrically insulating pedestal member provided between the metal portion and the slider. The slider support portion may include a first pedestal member and a second pedestal member, the first pedestal member and the second pedestal member being electrically insulating. The first pedestal member covers the aperture portion. The second pedestal member is provided between the slider and the first pedestal member.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a suspension of the first embodiment.

FIG. 2 is a plan view showing a part of this suspension.

FIG. 3 is a cross-sectional view showing an example of a disk drive.

FIG. 4 is a cross-sectional view of a slider arrangement portion along F4-F4 line in FIG. 2.

FIG. 5 is a cross-sectional view of the slider arrangement portion along F5-F5 line in FIG. 4.

FIG. 6 is a cross-sectional view of a slider arrangement portion of the second embodiment.

FIG. 7 is a cross-sectional view of a slider arrangement portion of the third embodiment.

FIG. 8 is a cross-sectional view of a slider arrangement portion of the fourth embodiment.

FIG. 9 is a cross-sectional view of a slider arrangement portion of the fifth embodiment.

FIG. 10 is a cross-sectional view of a slider arrangement portion of the sixth embodiment.

FIG. 11 is a cross-sectional view of a slider arrangement portion of the seventh embodiment.

FIG. 12 is a cross-sectional view of a slider arrangement portion of the eighth embodiment.

### DETAILED DESCRIPTION OF THE INVENTION

### First Embodiment

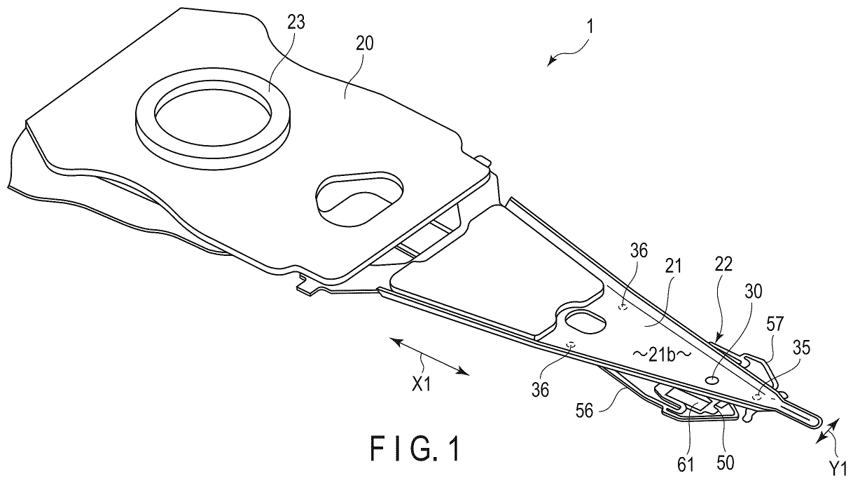

The following describes a suspension comprising a slider arrangement portion of the first embodiment with reference to FIG. 1 to FIG. 5.

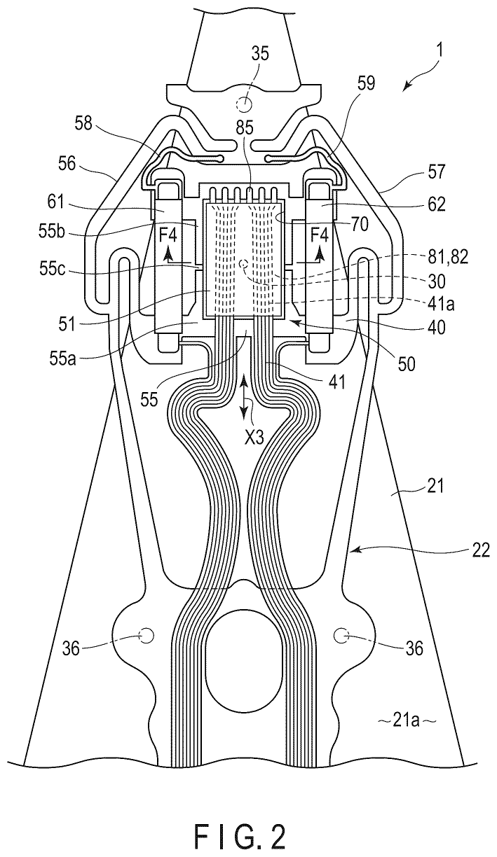

FIG. 1 is a perspective view of a suspension 1. FIG. 2 is a plan view of a part of the suspension 1. Double-headed arrow X1 in FIG. 1 indicates the length direction of the suspension 1. Double-headed arrow Y1 in FIG. 1 indicates the width direction of the suspension 1.

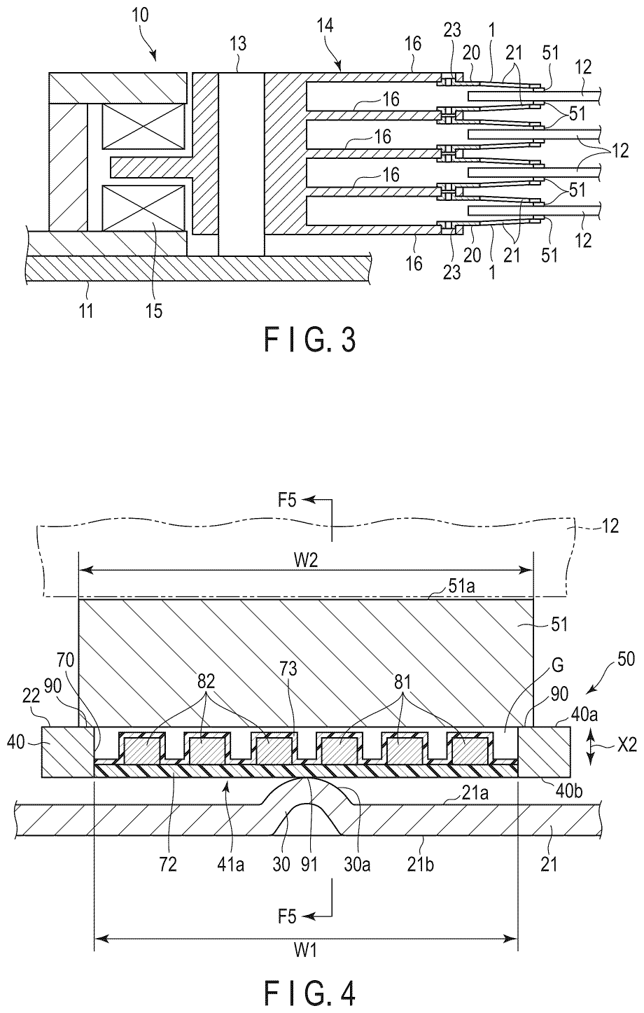

FIG. 3 is a cross-sectional view schematically showing an example of a disk drive 10. The disk drive 10 comprises a casing 11 (partially shown), a disk 12 rotating around a spindle, a carriage 14, a positioning motor 15, and the like. The carriage 14 pivots around a pivot 13. The motor 15 drives the carriage 14. A lid hermetically seals the casing 11. The suspension 1 is attached to the tip portion of an arm 16 of the carriage 14.

As shown in FIG. 1, the suspension 1 includes a baseplate 20, a load beam 21, and a flexure 22. The baseplate 20 is formed of, for example, a plate of stainless steel. A boss portion 23 of the baseplate 20 is secured to the carriage 14 (shown in FIG. 3). For example, the baseplate 20 has a thickness of 100 to 300 μm. The thickness is not limited to these values.

The load beam 21 extends in the length direction of the suspension 1. For example, the load beam 21 has a thickness of 20 to 40 μm. The thickness is not limited to these values. The load beam 21 has a first face 21a on which the flexure 22 is provided, and a second face 21b opposite to the first face 21a.

A dimple portion 30 is formed near the tip of the load beam 21. The dimple portion 30 includes a protrusion portion 30a. The protrusion portion 30a protrudes from the first face 21a of the load beam 21 to the flexure 22. The dimple portion 30 is inwardly bent from the second face 21b of the load beam 21. Thus, the protrusion portion 30a is called a dimple as well in the industry. The protrusion portion 30a protrudes toward the flexure 22.

The flexure 22 is secured to the load beam 21 by welding portions 35 and 36 (partially shown in FIG. 1 and FIG. 2). The flexure 22 extends along the load beam 21 in the length direction of the suspension 1. The flexure 22 includes a metal base 40 and a circuit portion 41. The metal base 40 is formed of a stainless-steel plate thinner than the load beam 21. The circuit portion 41 is provided along the metal base 40. The metal base 40 has a thickness of, for example, 20 μm (12 to 25 μm). The thickness is not limited to these values.

A slider arrangement portion 50 is formed near the tip of the flexure 22. A slider 51 functioning as a magnetic head is provided on the slider arrangement portion 50. The slider 51 is provided with elements for magnetically recording data on the disk 12, elements for reading data recorded on the disk 12, and the like.

The slider arrangement portion 50 includes a plate portion 55 (shown in FIG. 2) composed of a part of the metal base 40. The plate portion 55 is called a tongue as well in the industry. The plate portion 55 of the present embodiment is supported by arm portions 56 and 57, limiter portions 58 and 59, and the like such that the plate portion 55 is swingable with respect to the load beam 21. The plate portion 55 includes a first plate 55a and a second plate 55b. The first plate 55a and the second plate 55b each can slightly move slightly in the width direction of the suspension 1 with respect to a slit 55c.

Actuator elements 61 and 62 are provided on respective sides of the slider 51. Each of the actuator elements 61 and 62 is formed of a piezoelectric body such as zirconate titanate (PTZ). When a voltage is applied to the actuator elements 61 and 62, a piezoelectric body extends and contracts in accordance with the applied voltage. Thus, the tip side of the slider 51 can be slightly moved in the width direction (direction indicated by the Double-headed arrow Y1 in FIG. 1) of the suspension 1. Elements for reading and writing of data are provided on the tip side of the slider 51.

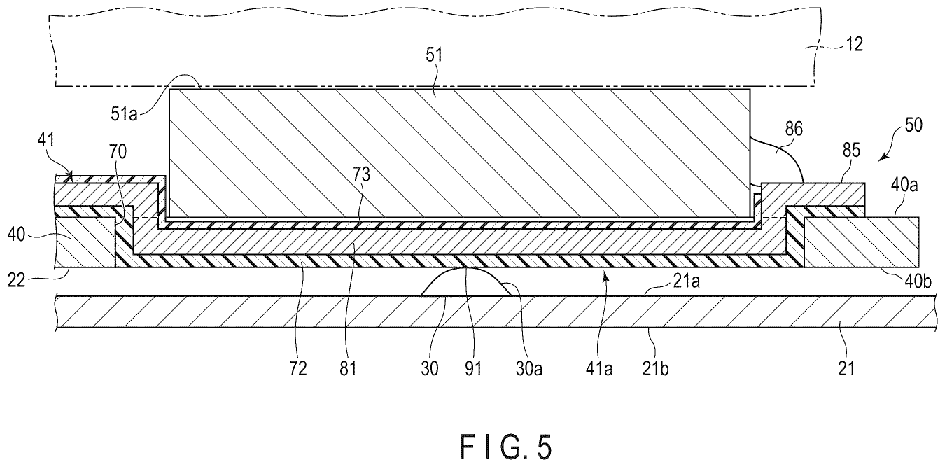

FIG. 4 is a cross-sectional view of the slider arrangement portion 50 along F4-F4 line in FIG. 2. FIG. 5 is a cross-sectional view of the slider arrangement portion 50 along F5-F5 line in FIG. 4. Double-headed arrow X2 in FIG. 4 indicates the thickness direction of the metal base 40. The metal base 40 includes a first surface 40a corresponding to a side on which the slider 51 is arranged, and a second surface 40b facing the load beam 21.

The slider arrangement portion 50 includes an aperture portion 70 formed in the metal base 40. The aperture portion 70 is open in the thickness direction of the metal base 40. The aperture portion 70 of the present embodiment is open toward the first surface 40a and the second surface 40b of the metal base 40. The aperture portion 70 may be open toward the first surface 40a (the side on which the slider 51 is provided) alone. A width W1 (shown in FIG. 4) of the aperture portion 70 is smaller than a width W2 of the slider 51.

As shown in FIG. 4 and FIG. 5, an embedding circuit portion 41a may be provided inside the aperture portion 70. The embedding circuit portion 41a constitutes a part of the length direction of the circuit portion 41. Double-headed arrow X3 in FIG. 2 indicates the length direction of the circuit portion 41.

The embedding circuit portion 41a includes a base resin layer 72, a plurality of conductors (for example, the first conductor 81 and the second conductor 82), and a cover resin 73. Each of the base resin layer 72 and the cover resin 73 is formed of an electrically insulating resin such as polyimide. The first conductor 81 and the second conductor 82 are described as examples in the present embodiment. The number of the conductors and the shape are not limited to the examples to be described in the present embodiment. The conductors 81 and 82 are covered with the base resin layer 72 and the cover resin 73.

As shown in FIG. 2 and FIG. 5, a terminal portion 85 and an electrically conductive member 86 electrically connect an end of the circuit portion 41 to a terminal of the slider 51. The conductors 81 and 82 are mainly formed of copper. A plated layer of gold and the like is provided outside copper as necessary. To simplify the figures, the illustration of the plated layer is omitted in the figures. The plated layer may not be provided on the conductor.

A slider support portion 90 is formed on the first surface 40a of the metal base 40. The slider support portion 90 is a part of the metal base 40 and is substantially flat. The slider 51 is fixed to the slider support portion 90 by means of a fixing means such as bonding. A gap G (shown in FIG. 4) is formed between the cover resin 73 of the embedding circuit portion 41a and the slider 51. Electrically insulating resins may fill the gap G.

As shown in FIG. 4 and FIG. 5, an abutting portion 91 is formed on the base resin layer 72 of the embedding circuit portion 41a. The protrusion portion 30a (near the apex of the dimple portion 30) of the load beam 21 contacts the abutting portion 91. The protrusion portion 30a protrudes from the first face 21a of the load beam 21 to the slider arrangement portion 50. Thus, the slider arrangement portion 50 can swing around the protrusion portion 30a in the thickness direction of the metal base 40.

The slider arrangement portion 50 of the present embodiment may include the embedding circuit portion 41a. The embedding circuit portion 41a is provided inside the aperture portion 70. The slider support portion 90 supports the slider 51 with the embedding circuit portion 41a being provided in the aperture portion 70. The slider support portion 90 is a part of the metal base 40 and is substantially flat. Therefore, the slider 51 is supported by the slider support portion 90 in a stable orientation. Further, the distance between the disk 12 and an air bearing formation surface 51a (flying height of the slider) can be accurately controlled. The flying height of the slider is extremely small. Thus, accurate control of the orientation of the slider 51 is crucial.

In the slider arrangement portion 50 of the present embodiment, the protrusion portion 30a (the apex of the dimple) of the load beam 21 contacts the abutting portion 91 of the embedding circuit portion 41a. The embedding circuit portion 41a is provided in the aperture portion 70. Thus, the distance between the apex of the dimple and the air bearing formation surface 51a can be reduced. This contributes to providing a slider arrangement portion 50 that is low profile. Further, the width of the slider arrangement portion 50 can be reduced.

The rotation of the disk 12 produces an air bearing between the disk 12 and the slider 51. Pivoting of the carriage 14 caused by the positioning motor 15 (shown in FIG. 3) moves the suspension 1 in the radial direction of the disk 12. The slider 51 is thereby moved to a desired position on the disk 12. When a voltage is applied to the actuator elements 61 and 62, the actuator elements 61 and 62 extend and contract. Thus, the tip side of the slider 51 can be moved in the width direction (direction indicated by the Double-headed arrow Y1 in FIG. 1) accurately and rapidly.

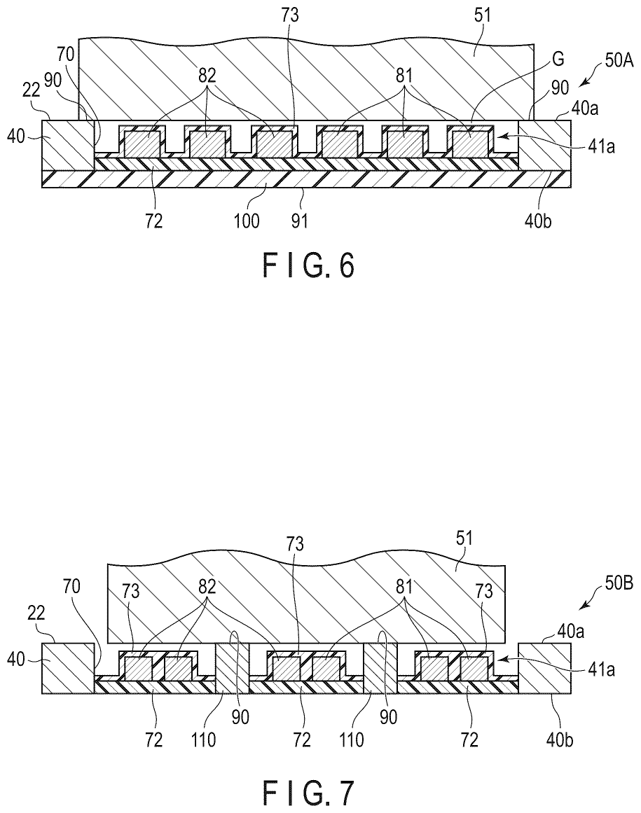

The following describes slider arrangement portions 50A to 50G of the second embodiment to the eighth embodiment with reference to FIG. 6 to FIG. 12. In these embodiments, the same reference numerals are added to the constituent elements that the slider arrangement portion 50 of the first embodiment and those of these embodiments have in common. Explanations of these elements are omitted.

### Second Embodiment

FIG. 6 is a cross-sectional view of a slider arrangement portion 50A of the second embodiment. The slider arrangement portion 50A includes a foundation resin 100. An abutting portion 91 contacting the apex of a dimple portion may be formed on the foundation resin 100. The foundation resin 100 is formed of an electrically insulating resin such as polyimide and overlaps a base resin layer 72. Since the other structures are common to those of the slider arrangement portion 50 of the first embodiment and the slider arrangement portion 50A, explanations thereof are omitted by adding common reference numbers to the common constituent elements.

### Third Embodiment

FIG. 7 is a cross-sectional view of a slider arrangement portion 50B of the third embodiment. The slider arrangement portion 50B includes a metal portion 110 composed of a part of a metal base 40. The metal portion 110 is formed inside an aperture portion 70. A slider support portion 90 is formed on the metal portion 110. Therefore, a slider 51 is supported by the slider support portion 90.

### Fourth Embodiment

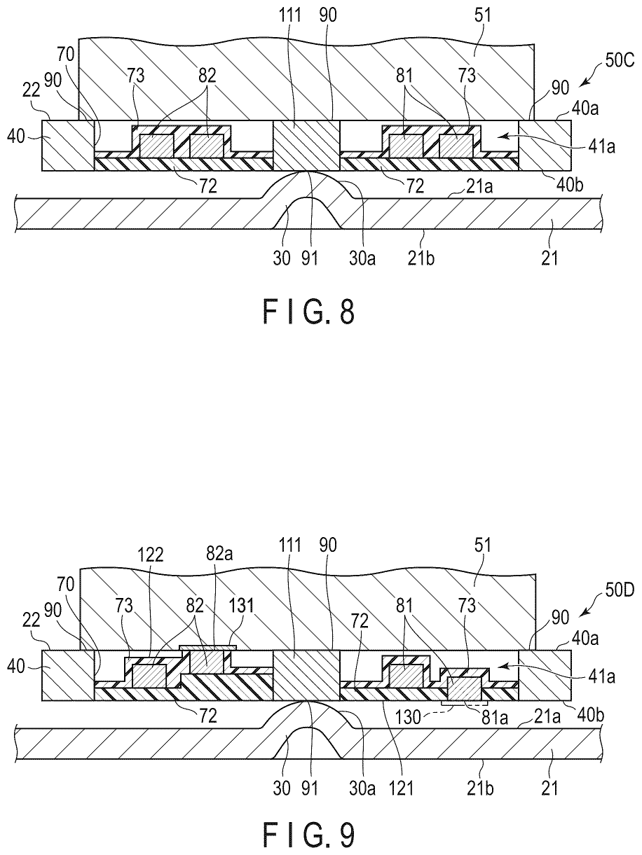

FIG. 8 is a cross-sectional view of a slider arrangement portion 50C of the fourth embodiment. The slider arrangement portion 50C includes an aperture portion 70. A metal portion 111 formed of a part of a metal base 40 is formed at the center of the aperture portion 70 in the width direction. A slider support portion 90 is formed on the slider-side face of the metal portion 111. An abutting portion 91 is formed on the load beam-side face of the metal portion 111.

### Fifth Embodiment

FIG. 9 is a cross-sectional view of a slider arrangement portion 50D of the fifth embodiment. An embedding circuit portion 41a of the slider arrangement portion 50D includes a load beam-side face 121 and a slider-side face 122. A terminal portion 81a is formed on a part of a first conductor 81. The terminal portion 81a is exposed to the load beam-side face 121. The terminal portion 81a is electrically connected to a terminal 130 of a flexure 22. A terminal portion 82a is formed on a part of a second conductor 82. The terminal portion 82a is exposed to the slider-side face 122. The terminal portion 82a is electrically connected to a terminal (a top-bond pad) 131 located on the rear surface side of the slider 51.

### Sixth Embodiment

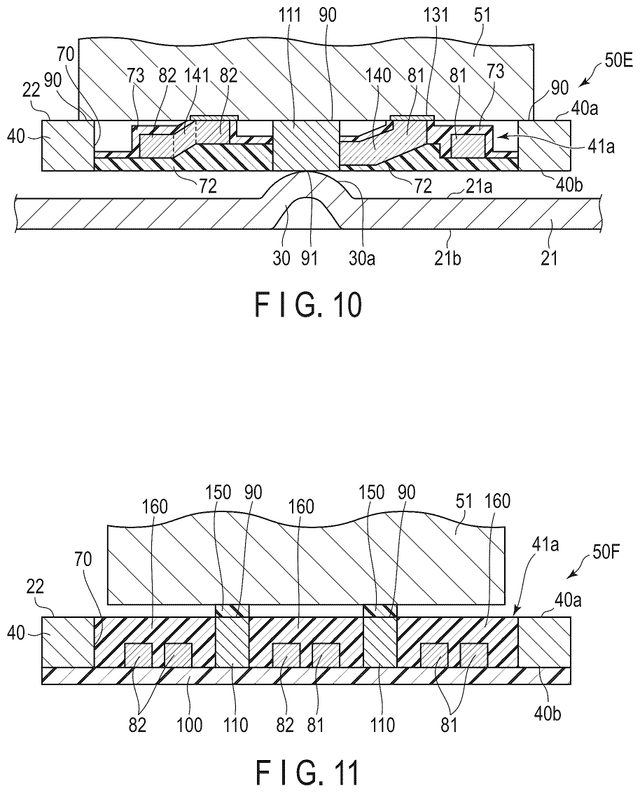

FIG. 10 is a cross-sectional view of a slider arrangement portion 50E of the sixth embodiment. The slider arrangement portion 50E includes a ground connecting conductor 140. The ground connecting conductor 140 electrically connects a part of the metal base 40 (the metal portion 111) and a terminal 131 located on the rear surface side of the slider 51. A connecting conductor 141 electrically connecting a plurality of second conductors 82 one another may be provided.

### Seventh Embodiment

FIG. 11 is a cross-sectional view of a slider arrangement portion 50F of the seventh embodiment. The slider arrangement portion 50F includes a metal portion 110 including a slider support portion 90 and a pedestal member 150 provided on the metal portion 110. The pedestal member 150 is formed of an electrically insulating resin. The slider support portion 90 including the pedestal member 150 supports the slider 51. An electrically insulating embedding resin 160 fills an aperture portion 70 formed in a metal base 40. Conductors 81 and 82 are provided on a foundation resin 100. The conductors 81 and 82 are embedded in the embedding resin 160.

### Eighth Embodiment

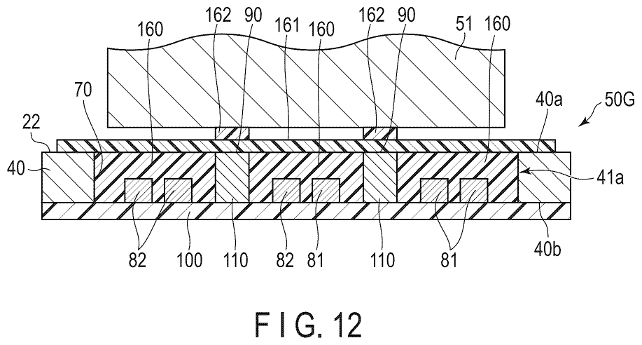

FIG. 12 is a cross-sectional view of a slider arrangement portion 50G of the eighth embodiment. The slider arrangement portion 50G includes a first pedestal member 161 and a second pedestal member 162. The first pedestal member 161 covers an aperture portion 70. The second pedestal member 162 overlaps the first pedestal member 161 in the thickness direction. The first pedestal member 161 and the second pedestal member 162 each are formed of an electrically insulating resin. A slider 51 is supported by a slider support portion 90 including the first pedestal member 161 and the second pedestal member 162. Since the other structures are common to those of the slider arrangement portion 50F of the seventh embodiment and those of the slider arrangement portion 50G, explanations thereof are omitted by adding common reference numbers to common structural elements.

Each of the slider arrangement portions 50, and 50A to 50G includes the embedding circuit portion 41a provided in the aperture portion 70. The metal base 40 includes the slider support portion 90. The slider 51 is supported by the slider support portion 90 with the embedding circuit portion 41a being provided in the aperture portion 70. This configuration enables arranging the slider 51 in a stable orientation and reducing the width of the slider arrangement portion as well.

In the slider arrangement portions 50 and 50A to 50G of the embodiments, the protrusion portion 30a (the apex of the dimple) of the load beam 21 contacts the abutting portion 91 with the embedding circuit portion 41a being provided in the aperture portion 70. This configuration shortens the distance between the apex of the dimple and the air bearing formation surface 51a and contributes to provide a slider arrangement portion that is low profile.

Needless to say, when implementing the present invention, the configuration of each element, such as the metal base and the circuit portion constituting the flexure can be modified variously. In addition, the aperture portion formed in the metal base, the slider support portion, and the abutting portion can also be implemented in various forms, as long as they do not deviate from the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive suspension comprising:
a load beam; and
a flexure, wherein
the flexure includes:
a metal base;
a circuit portion provided along the metal base; and
a slider arrangement portion on which a slider is arranged;
the slider arrangement portion includes:
an aperture portion formed in the metal base;
an embedding circuit portion arranged inside the aperture portion in a part of the circuit portion;
a slider support portion formed on the metal base and supporting the slider with the embedding circuit portion being arranged in the aperture portion; and
an abutting portion contacting a protrusion portion formed on the load beam.

2. The suspension of claim 1, wherein
the embedding circuit portion includes a base resin layer, a conductor along the base resin layer, a cover resin covering the conductor, and the abutting portion.

3. The suspension of claim 2, wherein
the slider arrangement portion includes a foundation resin overlapping the base resin layer.

4. The suspension of claim 1, further comprising:
a metal portion provided inside the aperture portion and formed of a part of the metal base, wherein
the metal portion includes the slider support portion.

5. The suspension of claim 4, wherein
the metal portion includes the abutting portion.

6. The suspension of claim 1, wherein
the embedding circuit portion includes:
a load beam-side face facing the load beam;
a slider-side face facing the slider;
a first conductor including a terminal portion exposed to the load beam-side face; and
a second conductor including a terminal portion exposed to the slider-side face.

7. The suspension of claim 1, further comprising:
a ground connecting conductor electrically connecting the metal base and a conductor of the embedding circuit portion.

8. The suspension of claim 4, wherein
the slider support portion includes:
an electrically insulating pedestal member provided between the metal portion and the slider.

9. The suspension of claim 1, wherein
the slider support portion includes:
an electrically insulating first pedestal member covering the aperture portion; and
an electrically insulating second pedestal member between the slider and the first pedestal member.
